(19) United States
(12) Patent Application Publication
(10) Pub. No.: US 2026/0005970 A1
(43) Pub. Date: Jan. 1, 2026

(54) BACKHAUL CONGESTION MITIGATION

(71) Applicant: T-Mobile USA, Inc., Bellevue, WA (US)

(72) Inventor: Bhagwan Singh Khanka, Bothell, WA (US)

(21) Appl. No.: 18/756,529

(22) Filed: Jun. 27, 2024

(51) Int. Cl. H04L 47/2416; H04L 43/0882; H04W 28/02

(52) U.S. Cl. CPC H04L 47/2416; H04L 43/0882; H04W 28/0252

(57) ABSTRACT

Systems and techniques for determining and mitigating congestion at a backhaul of a telecommunication network system are discussed herein. A backhaul controller may be located at or coupled to a backhaul of the telecommunication network and may be configured to determine network traffic congestion at the backhaul. The backhaul controller may determine potential or actual network traffic congestion by determining whether a bandwidth usage at the backhaul meets or exceeds a bandwidth threshold. When the bandwidth usage meets or exceeds the bandwidth threshold, the backhaul controller may determine and execute one or more actions configured to lower the bandwidth usage at the backhaul to below the bandwidth threshold.

### BACKGROUND

Telecommunication networks connect user devices with online services. Packets of voice traffic and data traffic typically travel to and from a user device to a server associated with an online service through a base station of a radio access network proximate a location of the user device, a backhaul that is communicatively coupled with the base station, and a core network that is communicatively coupled with the backhaul. As network traffic increases along the backhaul due to an increasing number of user devices being serviced by the backhaul, the network traffic being transmitted through the backhaul may become congested due to the backhaul reaching its bandwidth limit. When congested, this may result in dropped packets at the backhaul, missed frames at the backhaul, and retransmission of packets. On a user side, when the backhaul experiences congestion, the user may experience stuttering video, dropped calls, inability to load a website, and/or the like.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 illustrates an example computer architecture of a telecommunication network system.

FIG. 2 is a flow diagram illustrating an example process of mitigating the backhaul congestion.

FIG. 3 is a flow diagram illustrating an example process of mitigating the backhaul congestion associated with voice traffic.

FIG. 4 is a flow diagram illustrating an example process of mitigating the backhaul congestion associated with data traffic.

FIG. 5 is a flow diagram illustrating an example process of generating a data model that assists in proactively determining potential backhaul congestion.

FIG. 6 illustrates a flow diagram illustrating an example process of using the data model to proactively mitigate potential backhaul congestion.

### DETAILED DESCRIPTION

Systems and techniques for determining and mitigating congestion at a backhaul of a telecommunication network system are discussed herein. In some examples, the telecommunication network system may be a mobile or cellular network. In some examples, the cellular network may include a core network, one or more radio access networks (RAN), and a backhaul that is communicatively coupled with the radio access network(s) and the core network. In some examples, the radio access network may further be communicatively coupled with one or more user devices. In some examples, a backhaul controller may be located at or proximate the backhaul. In some examples, the backhaul controller may determine potential and/or actual congestion at the backhaul based on whether bandwidth usage at the backhaul meets or exceeds a bandwidth threshold. In some examples, when the bandwidth usage meets or exceeds a bandwidth threshold, the backhaul controller may determine and execute one or more actions to mitigate or reduce the congestion.

In some examples, the user device may be a computing device that is configured to communicatively couple with the cellular network. In some examples, the user device may be any suitable type of computing device, including, but not limited to, a mobile device (e.g., a smartphone, a mobile phone (also referred to as a cellular phone), a personal digital assistant (PDA), a tablet computer, or the like), a personal computer (PC), a laptop computer, a server, an embedded system, an Internet of Things (IoT) device, or any other sort of device or devices capable of communicating via the cellular network.

In some examples, the user device may include a user interface communicatively coupled with one or more processor(s), memory, and a networking component. The memory may be communicatively coupled with the processor(s). In some examples, the memory may include an operating system, an application component, and a network traffic determinator.

In some examples, the user interface may include components that permits a user to interact or interface with the user device. Examples of the user interface may include, but are not limited to, one or more displays, one or more touchscreens, a keyboard, a trackpad, a trackball, a mouse, one or more microphones, one or more speakers, one or more physical buttons, one or more haptic buttons, and/or the like. In some examples, the user interface may further be used to make or answer a video call or a voice call. In some examples, the user interface may also be used to interact or interface with the one or more applications (also referred to as apps).

In some examples, the operating system may be communicatively coupled with the processor(s), the memory, the user interface, the application component, and/or the networking component. In some examples, the operating system may be configured to manage resources and interface between one or more of the application component, the user interface, the networking component, and the memory, or the processor(s). In some examples, a user may use the user interface 104 to interface with the operating system to instruct the operating system to launch an app from the application component. Upon receiving the instruction to launch the app, the operating system may instruct the processor(s) to execute the app and communicatively couple the app to other components of the user device.

In some examples, the network traffic determinator may be configured to determine one or more of a type of network traffic being transmitted by the networking component and/or a network traffic priority associated with the network traffic. In some examples, the network traffic determinator may determine the type of network traffic based on the app that is communicatively coupled with the networking component and transmitting and/or receiving network traffic. For example, when the app is associated with a voice call service, the network traffic determinator may determine that the network traffic type is associated with voice traffic. As another example, when the app is associated with streaming media, downloading media, an online game, or video conferencing, the network traffic determinator may determine that the network traffic type is associated with data traffic. In some examples, the user device may use the networking component to transmit the network traffic type upstream concurrently with transmitting the network traffic and the RAN, backhaul, and/or the component may receive the network traffic type concurrently with the network traffic. In some examples, alternatively, the network traffic determinator may generate a network type identifier and include the network type identifier within a header of one or more packets of the network traffic. For example, a packet associated with the voice call app may include a network type identifier indicating that the packet is for a voice traffic.

In some examples, alternatively or additionally, the network determinator may determine the network traffic priority. In some examples, the priority may be determined based on an app type associated with the app. For example, network traffic for a streaming media app may be higher than network traffic for a productivity app. In some examples, the network traffic priority based on the app type may be included in the list of priority apps. Alternatively, a separate second list of priority apps may be used by the network traffic determinator to determine the network traffic priority based on the app type. In some examples, the network traffic determinator transmit a first network priority associated with the type of network of the app, a second network priority associated with the app type, or both the first network priority and the second network priority to the RAN, backhaul, and/or the core network concurrent with the network traffic. In some examples, the first network priority and/or the second network priority may be determined and/or classified by the network traffic determinator as having a high priority, a medium priority, or a low priority. In some examples, the network determinator may generate a network priority identifier and include the network priority identifier within the header of one or more packets of the network traffic. For example, a packet associated with video call app may include a network priority identifier indicating that the packet has priority traffic.

In some examples, the RAN may include networking component(s) that can network traffic from the user device and transmit the network traffic to the backhaul. In some examples, the RAN can include a base station which includes the networking component(s). In some examples, the base station may further include a tower and networking component(s) that may include an antenna that is position at or proximate an apex of the tower. In some examples, the RAN may be able to receive network traffic from user devices positioned within a geographical region (also referred to as a service area or coverage area). In some examples, the size of the coverage area may be based on an initial random access channel (RACH) power of the RAN. In some examples, the initial RACH power of the RAN may be increased or decreased to increase or decrease the service area, respectively.

In some examples, the backhaul may include a backhaul controller. In some examples, the backhaul controller may be configured to determine whether the backhaul may be experiencing potential or actual congestion. In some examples, the backhaul controller may determine potential or actual congestion based on whether bandwidth usage at the backhaul is at or above a backhaul bandwidth threshold. In some examples, the bandwidth threshold may be set at a level at or below a maximum bandwidth associated with the backhaul. In some examples, the backhaul controller can determine and execute an action to mitigate the congestion and bring the bandwidth usage below the bandwidth threshold.

In some examples, the backhaul controller may further determine whether the network traffic that is causing the congestion is voice traffic or data traffic. In some examples, the backhaul controller may determine the voice traffic or the data traffic based on the network type identifier. In some examples, the backhaul controller may determine first action(s) to mitigate voice traffic congestion and second action(s) to mitigate data traffic. Examples of the first action(s) may be, but are not limited to, increasing coding of voice traffic by the RAN, preferring the RAN to transmit voice traffic associated with a handover, and increasing a backoff timer duration at the RAN associated with the voice traffic. Examples of the second action(s) may be, but are not limited to, reducing max data rate per customer associated with the backhaul, increasing a backoff timer duration at the RAN associated with the data traffic, and lowering the initial RACH power of the RAN.

In some examples, when determining the second action(s), the backhaul controller may determine a priority associated with the data traffic. In some examples, the priority may be determined based on the network traffic priority identifier. In some examples, a magnitude of reduction of maximum data rate for the user device and the magnitude of the increase in the backoff timer may depend on the priority. For example, higher priority may result in the magnitude of reduction of the maximum data rate to be lower (e.g., less reduction) and the increase in the backoff timer duration to be lower. In some examples, the backhaul controller may additionally or alternatively generate a data model that assists in proactively mitigating congestion based on identifying events that often result in congestion. In some examples, the backhaul controller may use the data model to determine the first action(s) and/or the second action(s) in place of or in addition to the bandwidth threshold.

In some examples, the techniques discussed herein can improve how a telecommunication network mitigates congestion within the network. In some examples, the techniques discussed herein can improve the user experience when using the telecommunication network by lowering the chances that the user may experience dropped frames, buffering, and lag. Additional improvements are discussed throughout this disclosure.

The techniques discussed herein can be implemented in the context of mobile network protocols such as one or more of 3G, 4G, 4G LTE, 5G, Wi-Fi, Bluetooth, or other protocols. In some examples, the techniques discussed herein can be implemented at a network that is internal to a facility. Example implementations are provided below with reference to the following figures.

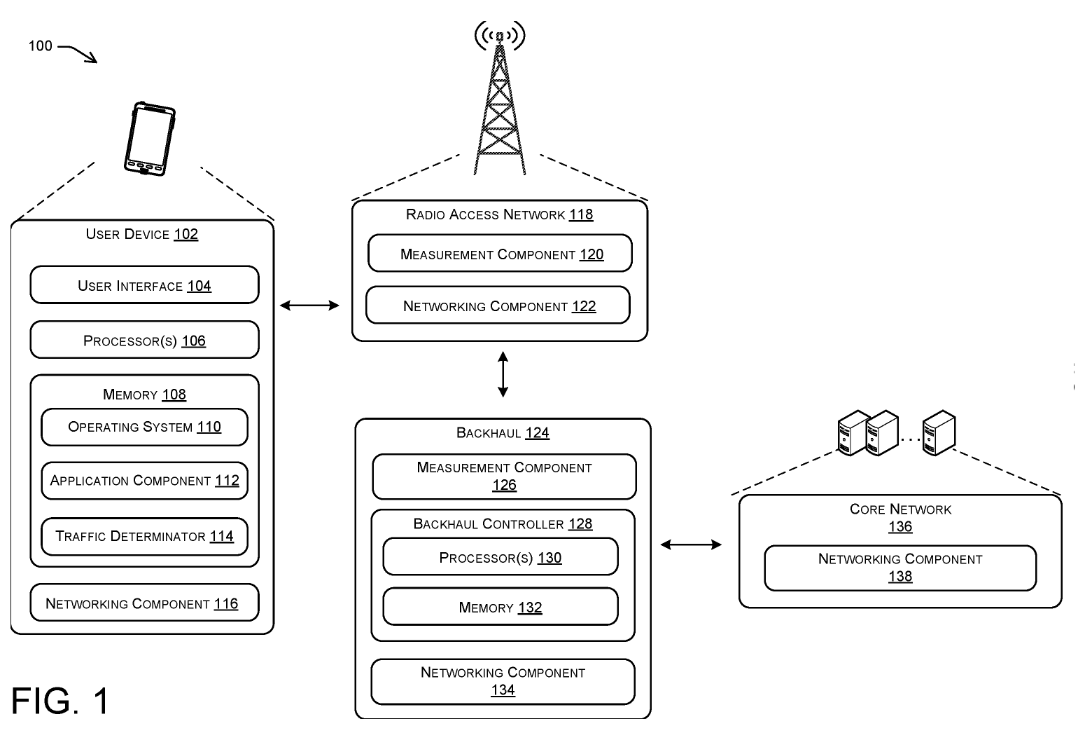

FIG. 1 illustrates an example computer architecture 100 of a network system. In some examples, the network system may be a telecommunication network, such as a cellular network. The example computer architecture 100 includes user device 102 (also referred to as a user equipment), radio access networking component (also referred to as a RAN) 118, backhaul 124, and core network 136. In some examples, the RAN 118, the backhaul 124, and the core network 136 may be components within a cellular network or a mobile network.

In some examples, the user device 102 may be any suitable type of computing device, including, but not limited to, a mobile device (e.g., a smartphone, a mobile phone (also referred to as a cellular phone), a personal digital assistant (PDA), a tablet computer, or the like), a personal computer (PC), a laptop computer, a server, an embedded system, an Internet of Things (IoT) device, or any other sort of device or devices capable of communicating via the RAN 118, the backhaul 124, and the core network 136.

The user device 102, as illustrated in FIG. 1, may include a user interface 104 communicatively coupled with one or more processor(s) 106, memory 108, and a networking component 116. The memory 108 may be communicatively coupled with the processor(s) 106. In the illustrated example, the memory 108 stores an operating system 110(also referred to as an operating system component), an application component, and a network traffic determinator (also referred to as a network traffic determination component). Though depicted as residing in the memory 108, it is contemplated that the operating system 110, the one or more apps, and the network traffic determinator can additionally or alternatively be stored at another component of the user device 102 while be accessible to the user device 102. In some examples, the processor(s) 106 may be used to execute instructions provided by one or more of the user interface 104, the operating system 110, the one or more app(s), or the network traffic determinator. In some examples, the memory 108 may include one or more of volatile computer-readable media or memory or non-volatile computer-readable media or memory.

In some examples, the user interface 104 may include components that permit a user to interact or interface with the user device 102. Examples of the user interface 104 may include, but are not limited to, one or more displays, one or more touchscreens, a keyboard, a trackpad, a trackball, a mouse, one or more microphones, one or more speakers, one or more physical buttons, one or more haptic buttons, and/or the like. In some examples, the user interface 104 may be used to display a prompt or a notification generated by the processor(s) 106 and may be used by the user to interact with the display prompt such as inputting a response based on the displayed prompt or notification. In some examples, the user interface 104 may further be used to make or answer a video call or a voice call. In some examples, the user interface 104 may also be used to interact or interface with the one or more apps.

In some examples, the operating system 110 may be communicatively coupled with the processor(s), the memory, the user interface, the application component, and/or the networking component. In some examples, the operating system 110 may be configured to manage resources and interface between one or more of the application component 112, the user interface 104, the networking component 116, and the memory 108, or the processor(s) 106. In some examples, a user may use the user interface 104 to interface with the operating system to instruct the operating system to launch an application (also referred to as an app) from the application component (e.g., using a touchscreen to touch an icon on the operating system 110’s graphical user interface (GUI) that is associated with the app to launch the app). Upon receiving the instruction to launch the app, the operating system 110 may instruct the processor(s) to execute the app and communicatively couple the app to other components of the user device 102. For example, the app may be a streaming video app and the operating system may communicatively couple the streaming video app with the networking component and the network traffic determinator.

In some examples, the network traffic determinator 114 may be configured to determine one or more of a type of network traffic being transmitted by the networking component and/or a network traffic priority associated with the network traffic. In some examples, the network traffic determinator 114 may determine the type of network traffic based on the app that is communicatively coupled with the networking component 116 and transmitting and/or receiving network traffic. For example, when the app is associated with a voice call service, the network traffic determinator 114 may determine that the network traffic type is associated with voice traffic. As another example, when the app is associated with streaming media, downloading media, an online game, or video conferencing, the network traffic determinator 114 may determine that the network traffic type is associated with data traffic. In some examples, the user device 102 may use the networking component to transmit the network traffic type upstream concurrently with transmitting the network traffic and the RAN, backhaul, and/or the component may receive the network traffic type concurrently with the network traffic. In some examples, alternatively, the network traffic determinator 114 may generate a network type identifier and include the network type identifier within a header of one or more packets of the network traffic. For example, a packet associated with the voice call app may include a network type identifier indicating that the packet is for a voice traffic.

In some examples, the network traffic determinator 114 may also determine the network traffic priority based on the app communicatively coupled with the network traffic determinator 114 and transmitting and/or receiving network traffic. In some examples, the network traffic determinator 114 may determine the network traffic priority based on a list of priority apps. In such an example, the network traffic determinator 114 may receive the list of priority apps from a service provider associated with the RAN 118, the backhaul 124, and the core network 136. In some examples, the network traffic determinator 114 may continuously or from time to time an updated list of priority apps from the service provider.

In some examples, alternatively or additionally, the network traffic determinator 114 may determine the network traffic priority based on an app type associated with the app. For example, network traffic for a streaming media app may be higher than network traffic for a productivity app. In some examples, the network traffic priority based on the app type may be included in the list of priority apps. Alternatively, a separate second list of priority apps may be used by the network traffic determinator 114 to determine the network traffic priority based on the app type. In some examples, the network traffic determinator 114 transmits a first network priority associated with the type of network traffic of the app, a second network priority associated with the app type of the app, or both the first network priority and the second network priority to the RAN 118, backhaul 124, and/or the core network concurrent with the network traffic. In some examples, the first network priority and/or the second network priority may be determined and/or classified by the network traffic determinator 114 as having a high priority, a medium priority, or a low priority. In some examples, the network traffic determinator 114 may generate a network priority identifier and include the network priority identifier within the header of one or more packets of the network traffic. For example, a packet associated with video call app may include a network priority identifier indicating that the packet has priority traffic.

In some examples, the networking component 116 can include physical and/or logical interfaces for connecting the user device 102 to another computing device or one or more external networks via the RAN 118, the backhaul 124, and the core network 136. For example, the networking component 116 can enable Wi-Fi-based communication such as via frequencies defined by the IEEE 802.11 standards, short range wireless frequencies such as Bluetooth, cellular communication (e.g., 2G, 3G, 4G, 4G LTE, 5G, etc.), satellite communication, terrestrial communication, dedicated short-range communications (DSRC), or any suitable wired or wireless communications protocol that enables the respective computing device to interface with the other computing device(s) or external networks.

In some examples, the RAN 118 may include measurement component 120 and networking component 122. In some examples, the measurement component 120 may be configured to measure or determine a current bandwidth usage at the RAN. In some examples, the networking component 122 may include, but is not limited to, one or more antenna(s), radio(s), and/or baseband unit(s). The RAN 118 may be communicatively coupled with user device 102 downstream and the backhaul 124 upstream. In some examples, the RAN 118 may receive first network traffic from the user device 102 and transmit the first network traffic to the core network 136 via the backhaul 124. In some examples, the RAN 118 may receive second network traffic from the core network 136 via the backhaul 124 and transmit the second network traffic to the user device 102.

While FIG. 1 illustrates that the RAN 118 being communicatively coupled to a single user device 102, it is contemplated that RAN 118 may be communicatively coupled to multiple user devices. In some examples, the RAN 118 may include a base station that includes the networking component 122. In such a scenario, the base station may include a tower and the networking component 122 may be positioned at the tower where the antenna may be positioned proximate an apex of the tower to maximize a range of the RAN 118. In some examples, all or most user devices within the range of the RAN 118 (also referred to as a first range) may be communicatively coupled with the RAN. In some example, the size of the range may be determined based on random access channel (RACH) power associated with the RAN 118. For example, increasing the RACH power associated with the RAN 118 may increase the size of the range. Conversely, decreasing the RACH power may decrease the range. In some examples, a signal strength associated with the RAN 118 may change based on where within the range that the user device 102 is positioned. For example, the signal strength of the user device 102 that positioned proximate an edge of the range is lower than the signal strength of the user device 102 that is positioned closer to the networking component 122. In such a scenario, the lower signal strength may result in a slower transfer speed and a higher signal strength may result in a faster transfer speed. In some examples, the signal strength may decrease as the user device 102 moves further away from the networking component 122, and the signal strength may increase as the user device moves closer toward the networking component 122.

In some examples, the RAN 118 may be positioned proximate one or more other RANs. In some examples, the RAN 118 and the one or more other RANs may be communicatively coupled with the backhaul 124. Alternatively, RAN 118 and at least one RAN of the one or more other RANs may be communicatively coupled with different RANs. For example, the RAN 118 may be communicatively coupled with the backhaul 124 as illustrated and a second RAN different from the RAN 118 may be communicatively coupled with a second backhaul different from the backhaul 124. In some examples, the second RAN may have a second range where all or most user devices within the second range are communicatively coupled with the second RAN. In some examples, the first range associated with the RAN 118 and the second range associated with the second RAN may have one or more regions that overlap (also referred to as an overlapping region). In such a scenario, as user device 102 moves from a region that is covered exclusively by the first range into the overlapping region, the RAN 118 may proactively initiate or be instructed to initiate a handover or handoff procedure where the network traffic associated with the user device 102 is transferred from being communicatively coupled with the RAN 118 to being communicatively coupled with the second RAN. In some examples, during the handover procedure, the network traffic may be transferred between the RAN 118 and the second RAN in such a way that minimally impacts a user experience. For example, when the user is on a voice call using the user device 102, the voice call traffic may be transferred from the RAN 118 to the second RAN without the voice call disconnecting during the handover procedure.

In some examples, in order to ensure that the handover procedure minimally impacts the user experience, the RAN 118 and the second RAN may perform a soft handover where both the RAN 118 and the second RAN simultaneously handles the network traffic from the user device 102 while the user device 102 is within the overlapping area and/or while the measurement component 120 and/or the network traffic determinator 114 is determining, while the user device 102 is in the overlapping region, that the second RAN is successfully transmitting and/or receiving the network traffic associated with the user device 102. Once the second RAN is determined to be successfully transmitting and/or receiving the network traffic, the RAN 118 may fully handover the network traffic to the second RAN and disconnect from the user device 102.

In some examples, RAN 118 may alternatively perform a hard handover where the connection between the RAN 118 and the user device 102 is disconnected before or simultaneously with when the connection between the second RAN and the user device 102 is made. In some examples, the hard handover may be preferred to the soft handover when the user device 102 is unable to or is incapable of connecting to multiple RANs.

In some examples, the user device 102 may instruct the RAN 118 to initiate the handover procedure to the second RAN based on determining that a signal strength associated with the RAN 118 is decreasing and a signal strength associated with the second RAN is increasing and/or based on a location associated with the user device 102. For example, the user device 102 may include a localization component such as a global positioning system (GPS) component and the user device 102 may use the localization component to determine that the user device 102 is moving away from a location associated with the RAN 118 and toward a location associated with the second RAN.

Alternatively, in some example, the RAN 118 and/or the second RAN may proactively initiate the handover procedure without instruction(s) from the user device 102. In some examples, the RAN 118 and/or the second RAN may initiate the handover procedure based on the measurement component 120 determining that the signal strength associated with the user device 102 at the RAN 118 is below a signal threshold and/or the signal strength associated with the user device 102 at the second RAN is above the signal threshold. In some examples, measurement component 120 may be configured to measure the signal strength associated with the RAN 118 and receive the signal strength associated with the second RAN from the second RAN. In such a scenario, a measurement component at the second RAN may measure the signal strength associated with the second RAN. Alternatively, the measurement component 120 can measure the signal strength associated with RAN 118 and the signal strength associated with the second RAN. In such a scenario, it is contemplated that the measurement component 120 may be positioned at a remote computing device separate from the RAN 118 and the second RAN where the remote computing device is communicatively coupled with the RAN 118 and the second RAN.

In some examples, the backhaul 124 may include measurement component 126, backhaul controller 128, and networking component 134. In the illustrated example, the backhaul 124 may be communicatively coupled with the RAN 118 and the core network 136. In some examples, the networking component 134 may be comprised of, but are not limited to, cable(s), fiber optic(s), and/or wireless component(s). In some examples, a total bandwidth associated with the backhaul 124 may be associated with whether the networking component comprises cable(s), fiber optic(s), or wireless components. For example, a backhaul comprised of copper line(s) generally has lower total bandwidth than a backhaul comprised of fiber optic(s).

In some examples, the measurement component 126 may measure a current bandwidth usage at the backhaul 124. In some examples, the measurement component 126 can also determine the current bandwidth usage as a percentage of the total bandwidth. In some examples, to determine that percentage, the measurement component can determine the total bandwidth based on whether the backhaul 124 is comprised of copper lines, fiber optics, or wireless components and/or receives the total bandwidth from elsewhere along the cellular or mobile network such as from the core network 136. Alternatively, the total bandwidth may be input by a user to the measurement component.

In some examples, the backhaul controller 128 may be physically located at the backhaul 124. In the illustrated example, the backhaul controller 128 may be physically coupled to the networking component 134. For example, a fiber optic of the backhaul 124 may be physically coupled with the backhaul controller 128 such that downstream network traffic may be transmitted through both the fiber optic and the backhaul controller 128 before reaching the RAN 118 and the upstream traffic may be transmitted through the fiber optic and backhaul from the RAN 118 before reaching the core network 136.

In the illustrated example, the backhaul controller 128 includes one or more processor(s) 130 and memory 132. While the illustrated example illustrates the measurement component 126 as being separate from the backhaul controller 128, it is contemplated that the measurement component 126 may be a component of the backhaul controller 128. For example, the measurement component 126 may be stored within the memory 132. In some examples, the memory 132 may also store a bandwidth threshold associated with the backhaul 124. In some examples, the backhaul controller 128 may determine, using the processor(s) 130, that when the current bandwidth usage meets or exceeds the bandwidth threshold, this may be indicative of actual backhaul congestion or potential backhaul congestion. Therefore, when the backhaul controller 128 determines that the bandwidth threshold is met or exceeded, the backhaul controller 128 may perform one or more actions that is executed by the processor(s) 130 and configured to mitigate or eliminate the actual backhaul congestion or the potential backhaul congestion. In some examples, the bandwidth threshold may be set at the total bandwidth associated with the backhaul 124 such that the one or more actions is taken only when actual congestion occurs. Alternatively, the bandwidth threshold may be set at an amount or percentage that is lower than the total bandwidth (e.g., at an amount that is less than 100% of the total bandwidth such as between 70% and 90% of the total bandwidth) such that the one or more actions may be performed before the actual congestion occurs and prevent the actual congestion from occurring. Examples of the one or more actions may include, but are not limited to, increase coding associated with network traffic, prefer network traffic associated with handovers, increase backoff timers associated with network traffic, reduce max data rate per customer or user, and lower RACH power associated with the RAN 118, and/or the like.

In some examples, the backhaul controller 128 may determine, using the processor(s) 130, whether the actual or potential backhaul congestion is associated with voice traffic or data traffic. In such a scenario, the backhaul controller 128 may separately receive, at the memory 132, or determine, using the processor(s) 130, a voice traffic threshold and a data traffic threshold and may determine whether the voice traffic threshold and/or the data traffic threshold has been exceeded. In some examples, the one or more actions performed may depend on whether the voice traffic threshold was exceeded or the data traffic threshold was exceeded.

In some examples, the backhaul controller 128 may be communicatively coupled with the RAN 118. In some examples, the backhaul controller 128 may also determine, using the processor(s) 130, whether a RAN bandwidth usage at the RAN 118 exceeds a RAN bandwidth threshold. Similar to those described in association with the backhaul 124, exceeding the RAN bandwidth threshold may indicate actual or potential congestion at the RAN 118. Whether the RAN bandwidth threshold indicates actual congestion or potential congestion depends on whether the threshold is set at a total RAN bandwidth or below the total RAN bandwidth. In the scenario where the RAN bandwidth usage exceeds the RAN bandwidth threshold, the backhaul controller 128 may determine, using the processor(s) 130, to not perform certain actions of the one or more actions that increases bandwidth usage at the RAN 118. In some examples, the RAN bandwidth threshold may also be categorized between voice traffic and data traffic. For example, when backhaul controller 128 determines, based on the network traffic type identifier, that the voice traffic at the RAN 118 exceeds at least the voice traffic threshold, the backhaul controller 128 may eliminate increasing coding at the RAN 118 from being one of the actions to take when the backhaul threshold is exceeded.

In some examples, the backhaul controller 128 may be communicatively coupled with a second backhaul controller that is associated with a second backhaul that is different from the backhaul 124. In some examples, the second backhaul may be associated with the second RAN. In some examples, when at least backhaul controller 128 determines that the data traffic threshold has been exceeded at the backhaul 124, the backhaul controller 128 may communicate with the second backhaul controller to determine whether the second backhaul have available data traffic bandwidth, and if so, the backhaul controller 128 may simultaneously instruct, using the processor(s) 130, the RAN 118 to reduce its initial RACH power such that the range associated with the RAN 118 is reduced and instruct, also using the processor(s) 130, the second backhaul controller to instruct the second RAN to increase its initial RACH power such that the range associated with the second RAN increases and due to the increased range, the second RAN is able to communicatively couple with user devices that have communicatively decoupled from the RAN 118 due to being outside of the decreased range associated with the RAN 118.

In some examples, the backhaul controller 128 may determine that due to the data traffic threshold at the backhaul 124 has been exceeded, it will instruct the backhaul 124 to reduce or restrict a per customer (or per user) data rate (e.g., each user device may be subject to slower data transfer speed). In some examples, the backhaul controller 128 may issue an instruction to for the backhaul 124 to reduce the data rate for all user devices communicatively coupled with the backhaul 124 to a same data rate. In some examples, the reduction in data rate may be determined on a data traffic priority basis. For example, the backhaul controller 128 may determine, based on receiving the network traffic priority identifier from the user device 102 that the data network traffic associated with the user device 102 has a highest priority, to exempt the user device 102 from the reduced data rate or allows the user device 102 to be subject to a smaller reduction in data rate while the network traffic associated with the user device 102 has the highest priority. For example, the data rate for the user device 102 may be reduced from 100 Megabits per second (Mbps) to 80 Mbps while the data rates for other user devices may be reduced from 100 Mbps to 50 Mbps. In some examples, the backhaul controller 128 may receive a user device identifier that exempts the user device 102 from being subject to the data rate reduction or allows the user device 102 from being subject to a smaller data rate reduction. In some examples, whether the user device 102 is subject to the data reduction may be determined based on whether the data network traffic associated with the user device 102 is associated with requiring low or ultra-low latency, and if so, then the user device 102 may be exempt from the data rate reduction while the user device 102 requires low or ultra-low latency. For example, the user device 102 may be exempt the data reduction while performing a video call or playing an online game.

While the illustrated example illustrates that the backhaul controller 128 is located at the backhaul 124, it is also contemplated that the backhaul controller 128 may be a separate computing device from the user device 102, the RAN 118, the backhaul 124, and the core network 136. Alternatively, it is contemplated that the backhaul controller 128 may be physically located at the RAN 118 or the core network 136.

In some examples, the core network 136 may include networking component 138. In some examples, the networking component 138 may include, but not limited to, hub(s), switch(es), bridge(s), router(s), gateway(s), and/or the like. In some examples, the core network 136 may communicatively couple the backhaul 124 (and by consequence, the user device 102) with one or more service provider(s). For example, the core network 136 may communicatively couple the backhaul 124 with computing devices such as servers that are associated with a streaming video service.

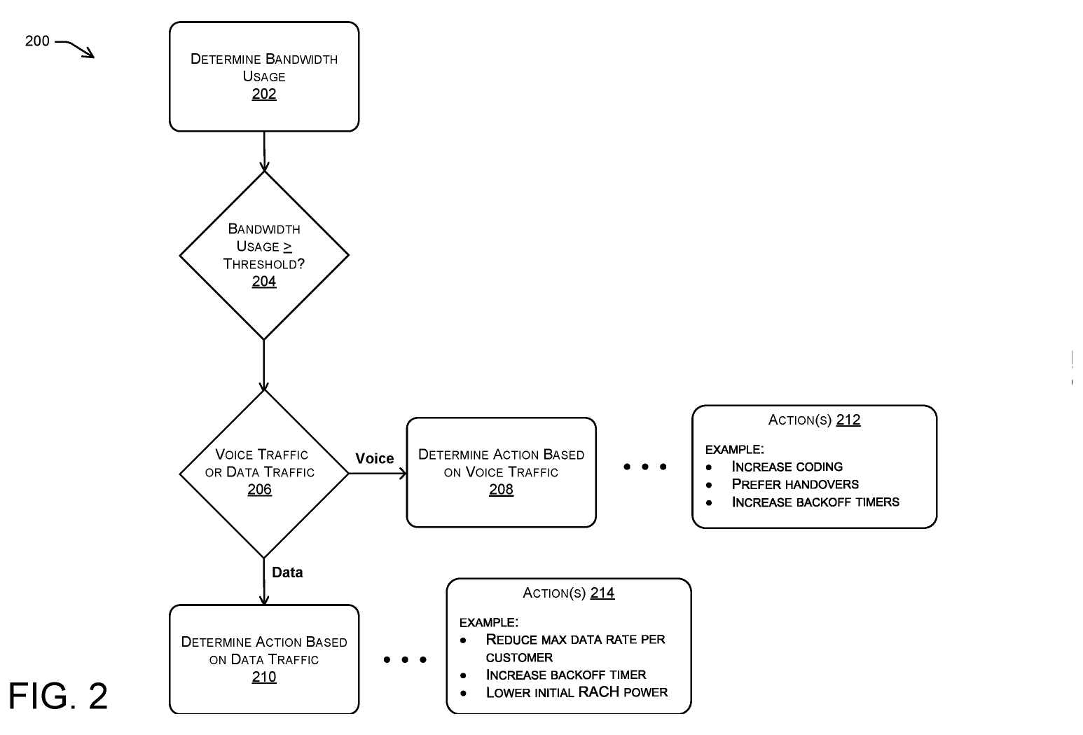

Additional details regarding the backhaul controller 128 taking action to mitigate actual or potential backhaul congestion at backhaul 124 are provided in connection with FIGS. 2-7, as well as throughout this disclosure.

FIG. 2 is a flow diagram illustrating an example process 200 of determining backhaul congestion and determining an action to mitigate the congestion. In some examples, the example process 200 may be performed by the backhaul controller 128.

At operation 202, the process includes determining bandwidth usage. In some examples, the bandwidth usage may be a current bandwidth usage. In some examples, the bandwidth usage may be determined continuously in real time. In some examples, the bandwidth usage may be determined in discrete time intervals (e.g., every 1 second, 5 seconds, 10 seconds, or the like). In some examples, the bandwidth usage may be determined based on the network traffic being transmitted through the backhaul 124 at a time or time interval of the bandwidth usage measurement. In some examples, the network traffic may include upstream network traffic from the user device 102 and the downstream network traffic from the core network 136. In some examples, rather than determining the bandwidth usage, the backhaul controller 128 can receive the bandwidth usage from the measurement component 126 of the backhaul 124. In some examples, at the operation 202, the process can further include determining a first bandwidth usage associated with the upstream network traffic and a second bandwidth usage associated with the downstream network traffic.

At operation 204, the process includes determining whether current bandwidth usage at the backhaul 124 meets or exceeds a bandwidth threshold. In some examples, the bandwidth threshold may be indicative of potential congestion at the backhaul 124 or actual congestion at the backhaul 124. In some examples, when the bandwidth threshold is set proximate the total bandwidth available for the backhaul 124 (e.g., above 90 or 95% of the total bandwidth), meeting or exceeding the bandwidth threshold may be indicative of actual congestion. In some examples, when the bandwidth threshold is set at a level below 90%, meeting or exceeding the bandwidth threshold may be indicative of potential congestion.

In some examples, the operation 204 may further or alternatively include determining whether the current bandwidth usage meets or exceeds a first bandwidth threshold and a second bandwidth. In some examples, the second bandwidth may correspond to the bandwidth threshold described above. In some examples, the first bandwidth may be a lower threshold (e.g., 70% or 80%) and the second bandwidth may be a higher threshold (e.g., 90%). In some examples, different actions may be determined based on whether the first bandwidth is met or exceeded or whether the second bandwidth is met or exceeded (e.g., at operation 208 or operation 210). In some examples, the action taken when the first bandwidth threshold is met or exceeded may be less severe than the action taken when the second bandwidth threshold is met or exceeded. For example, when the first bandwidth threshold is met or exceeded, the backhaul controller 128 may determine to increase backoff timers associated with the network traffic, and when the second bandwidth threshold is met or exceeded, the backhaul controller 128 may determine to reduce max data rate per customer.

In some examples, the operation 204 may, additionally or alternatively, include determining whether the network congestion is associated with the upstream network traffic and/or the downstream network traffic (e.g., whether a bandwidth threshold associated with the upstream traffic and/or a bandwidth threshold associated with the downstream traffic is met or exceeded). In some examples, the bandwidth threshold associated with the upstream traffic may be set at a first magnitude or percentage and the bandwidth threshold associated with the downstream traffic may be set at a second magnitude or percentage, where the first magnitude is different from the second magnitude. For example, in a scenario where the upstream bandwidth is smaller than the downstream bandwidth, the first magnitude may be smaller than the second magnitude.

At operation 206, the process includes determining whether the bandwidth usage that is causing the potential or actual congestion at the backhaul 124 is voice traffic or data traffic (e.g., a type of network traffic). In some examples, the backhaul controller 128 may determine the type of network traffic based on one or more packets associated with the network traffic. In some examples, each packet of the one or more packets may include an identifier that associates the packet with either voice traffic or data traffic. In some examples, the identifier may be located at a header of the packet. In some examples, alternatively, the type of traffic may be determined by the measurement component 126.

In some examples, a threshold associated with the voice traffic and a threshold associated with the data traffic may be received or determined at the backhaul controller 128. In some examples, in a scenario where the network traffic includes voice traffic and data traffic, the operation 206 may further include determining, based whether the threshold associated with the voice traffic and/or the threshold associated with the data traffic is met or exceeded, whether the potential or actual congestion at the backhaul 124 is associated with voice traffic and/or the data traffic. While in the illustrated example, the operation 206 is performed after the operation 204, the operation 206 may be performed before the operation 204 instead.

In some examples, the backhaul controller 128 may further determine whether the data traffic is associated with low latency data. Examples of low latency data may include, but are not limited to, data associated with streaming video, data associated with an online game, data associated with a real time video call, and/or the like. In some examples, the backhaul controller 128 may further determine or receive a threshold associated with low latency data and a separate threshold associated with other data (e.g., data not associated with the low latency data traffic). In some examples, the threshold associated with the low latency data may be at a lower magnitude or percentage than the threshold associated with the other data to prevent actual congestion from occurring during transmission of the low latency data. In some examples, the backhaul controller 128 may determine whether the data traffic is associated with the low latency data just at the upstream traffic. In some examples, the backhaul controller 128 may also determine whether the data traffic is associated with the low latency data also at the downstream traffic.

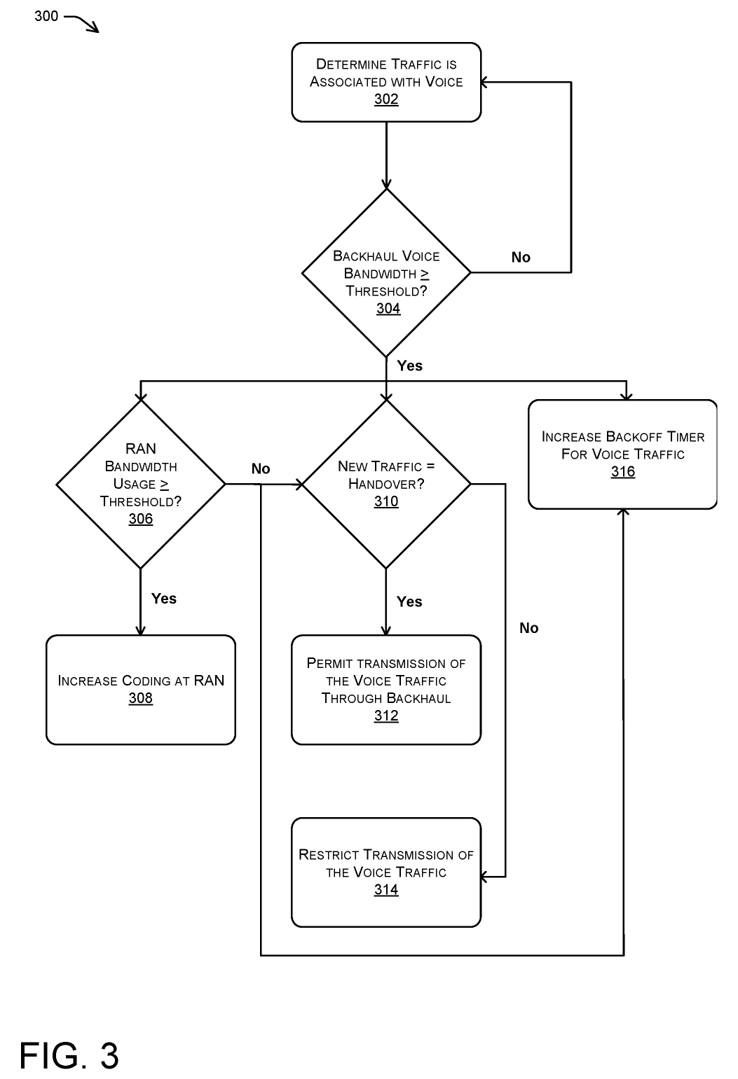

In some examples, when the congestion is associated with voice traffic, the process may continue to operation 208, where the backhaul controller 128 may determine one or more actions to mitigate potential or actual voice traffic congestion. Examples of the one or more actions are illustrated at action(s) 212 and may include, but are not limited to, increasing coding associated with the voice traffic, preferring handovers associated with existing voice calls, increasing backoff timers associated with the voice traffic, and/or the like. Additional details regarding the backhaul controller 128 taking action(s) to mitigate the actual or potential voice traffic congestion at backhaul 124 are provided in connection with FIG. 3, as well as throughout this disclosure

In some examples, when the congestion is associated with data traffic, the process may continue to operation 210, where the backhaul controller 128 may determine one or more actions to mitigate potential or actual data traffic congestion. Examples of the one or more actions are illustrated at action(s) 214 and may include, but are not limited to, reducing maximum data rate per customer or user, increasing backoff timer associated with the data traffic, lowering initial RACH power at the RAN 118, and/or the like.

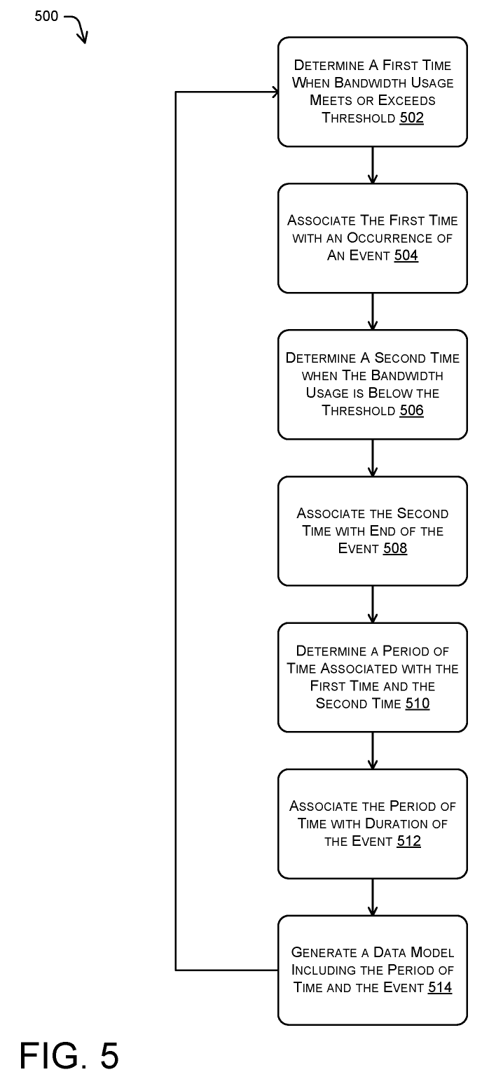

In some examples, the various thresholds discussed in association with the process 200, as well as throughout this disclosure, may be a fixed threshold. In some examples, alternatively, the various thresholds may be dynamically determined and/or updated. Additional details with respect to dynamically determining and/or updating the various thresholds are provided in association with FIG. 5, as well as throughout this disclosure.

FIG. 3 is a flow diagram illustrating an example process 300 of the mitigating voice traffic congestion. In some examples, the process 300 may be performed by the backhaul controller 128. In some examples, the process 300 may be performed as a part of the operation 208.

At operation 302, the process includes determining that network traffic at the backhaul 124 is associated with voice. Additional details with respect to the operation 302 are provided in association with FIG. 2, as well as throughout this disclosure.

At operation 304, once the network traffic is determined as being associated with voice, the process includes determining whether the voice traffic at the backhaul 124 meets or exceeds a voice bandwidth threshold. Additional details with respect to the operation 304 are provided in association with FIG. 2, as well as throughout this disclosure.

When the voice bandwidth threshold is met or exceeded, the process may proceed to one or more of the operation 306, the operation 310, or the operation 316. When the voice bandwidth threshold is not met or exceeded, the process may proceed back to the operation 302 where the backhaul controller 128 may continue monitoring network traffic at the backhaul 124 for potential or actual congestion.

At operation 306, the process can include determining whether bandwidth usage at the RAN 118 meets or exceeds a RAN bandwidth threshold. If no, then the process may proceed to operation 308 where the backhaul controller 128 may instruct the RAN 118 to increase coding of voice traffic. If yes, then the process may proceed to operation 310 and/or operation 316. Meeting or exceeding the RAN bandwidth threshold may indicate that there is not enough bandwidth available at the RAN 118 to facilitate increasing coding.

In some examples, the backhaul controller 128 may be communicatively coupled with the measurement component 120 and instruct the measurement component 120 to transmit current RAN bandwidth usage to the backhaul controller 128. The backhaul controller 128 may determine whether the current RAN bandwidth usage meets or exceeds the RAN bandwidth threshold. Alternatively, in some examples, the measurement component 120 may determine whether the current RAN bandwidth usage meets or exceeds the RAN bandwidth threshold and transmits an indication of whether the current RAN bandwidth usage meets or exceeds the RAN bandwidth threshold to the backhaul controller 128, and the backhaul controller 128 may determine whether to increase coding based on the indication.

At operation 308, the process can increase coding associated with voice traffic at the RAN 118. In some examples, increasing coding may include generating redundant voice traffic. For example, for each bit of voice traffic, one or more redundant bit associated with that bit may be generated by the RAN 118. In some examples, the bit and the redundant bit may be packaged into one packet and transmitted through the backhaul 124 towards a receiving device. In some examples, transmitting multiple bits of the same voice traffic may increase a probability that the voice traffic is successfully transmitted and reduce a probability that the voice traffic fails to transmit to the receiving device and thereby, reducing the probability that the user device 102 resending the bit again due to the receiving device not receiving the voice traffic and therefore, lowering the bandwidth usage at the backhaul 124. In some examples, the amount of redundant voice traffic generated at the RAN 118 may be based on an available RAN bandwidth. For example, when the backhaul controller 128 determines that the RAN has 20% bandwidth available, the backhaul controller 128 may instruct the RAN 118 to increase coding by generating one redundant bit per bit of voice traffic, and when the RAN has 40% bandwidth available, the backhaul controller 128 may instruct the RAN 118 to increase coding by generating two redundant bits per bit of voice traffic. In some examples, each additional redundant bit may increase the likelihood that the voice traffic is successfully transmitted to the receiving device.

At operation 310, the process includes determining whether new voice traffic is handover from another RAN and/or backhaul. In some examples, the measurement component 120 at the RAN 118 may determine whether the new voice traffic is a handover from another RAN based on communication between the RAN 118 and a second RAN when facilitating the handover, and may communicate an indication of the handover to the backhaul controller 128. In some examples, the backhaul controller 128 may determine whether the new voice traffic is a handover from another backhaul based on communication from a second backhaul during the handover. If yes, then the process may proceed to the operation 312 to permit the new voice traffic to transmit through the backhaul 124. If no, then the process may proceed to operation 314 to restrict transmission of the new voice traffic through the backhaul 124.

Alternatively, instead of permitting or restricting transmission of the voice traffic, the backhaul controller 128 can determine placing voice traffic associated with handover within a high priority queue and placing new voice traffic such as voice traffic from the user device 102 in a low priority queue. In some examples, the high priority queue may be associated with lower backoff timer than the low priority, near zero backoff timer, or no backoff timer while the lower priority queue may be associated with higher backoff timer than the high priority queue. In some examples, the higher backoff timer may result in the voice traffic within the low priority queue being permitted to transmit through the backhaul 124 after the voice traffic within the high priority queue.

At operation 316, the process can include increasing the backoff timer for voice traffic. In some examples, the backoff timer may be a period of time between transmission of voice traffic from a first user device associated with the RAN 118 and a second, different user device associated with the RAN 118 such as to avoid collision between the transmission of the voice traffic from the first user device and the transmission of the voice data from the second user device. In some examples, such a collision may result in at least the transmission from the first user device failing or the transmission from the second user device failing. In some examples, increasing the backoff timer may increase the period of time between the transmission from the first user device and the transmission from the second user device. The increase of the period of time may reduce bandwidth usage at the backhaul 124 by limiting the amount of concurrent voice traffic being transmitted through the backhaul 124 and therefore, may mitigate potential or actual congestion at the backhaul 124.

In some examples, once the backhaul controller 128 determines that voice bandwidth usage at the backhaul 124 is below the voice bandwidth threshold, the backhaul controller 128 may determine to stop the operations 308, 314, and/or 316. In some examples, the backhaul controller 128 may determine or receive a second voice bandwidth threshold lower than the voice bandwidth threshold such that during the operations 308, 314, and/or 316, when the voice bandwidth usage is at or above the voice bandwidth threshold or when the voice bandwidth usage is between the voice bandwidth threshold and the second voice bandwidth threshold, the backhaul controller 128 may determine to continue with the operations 308, 314, and/or 316, and when the voice bandwidth usage is below the second voice bandwidth threshold, the backhaul controller 128 may determine to stop the operations 308, 314, and/or 316 until the voice bandwidth threshold is exceeded again.

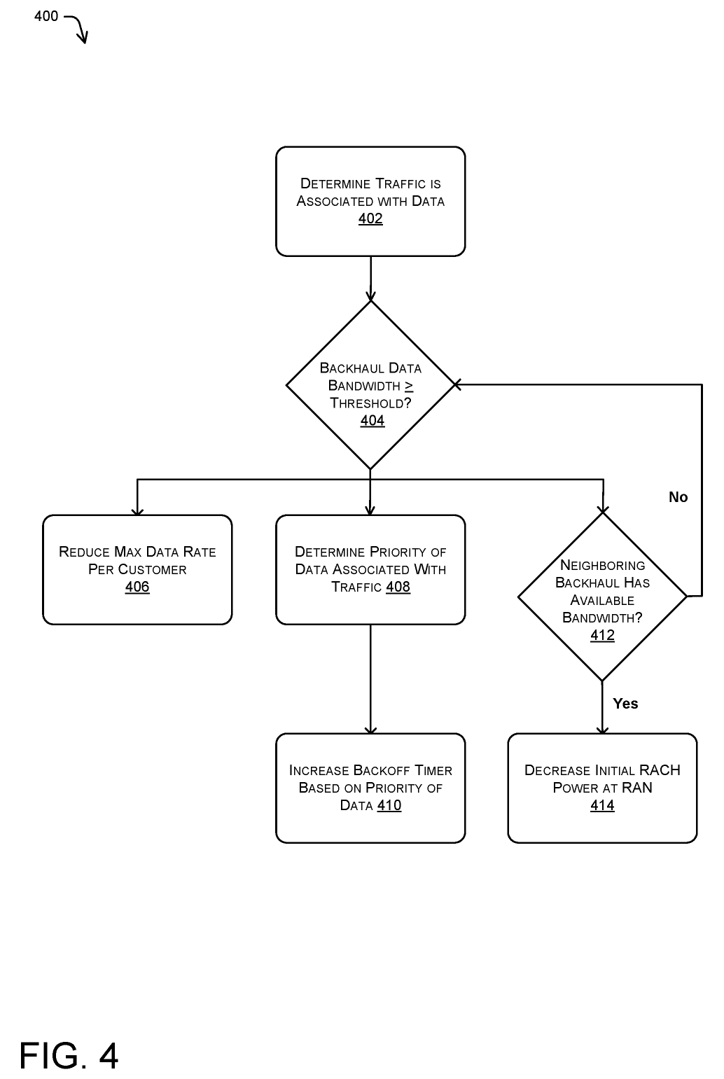

FIG. 4 is a flow diagram illustrating an example process 400 of the mitigating data traffic congestion. In some examples, the process 400 may be performed by the backhaul controller 128. In some examples, the process 300 may be performed as a part of the operation 210.

At operation 402, the process includes determining that network traffic at the backhaul 124 is associated with data Additional details with respect to the operation 402 are provided in association with FIG. 2, as well as throughout this disclosure.

At operation 404, the process includes determining, once the network traffic is determined as being associated with data, whether the data traffic at the backhaul 124 meets or exceeds a data bandwidth threshold. Additional details with respect to the operation 404 are provided in association with FIG. 2, as well as throughout this disclosure.

At operation 406, the process includes reducing maximum data rate per customer or user. In some examples, the operation 406 may include reducing the maximum data rate for at least one user device communicatively coupled with at least one RAN (e.g., the RAN 118) communicatively coupled with the backhaul 124. For example, executing the operation 406 may include reducing the maximum data rate for the user device 102.

In some examples, the backhaul controller 128 may determine to reduce the maximum data rate equally for all user devices that are associated with the backhaul 124. In some examples, alternatively, the backhaul controller 128 may determine that one or more RANs associated with the backhaul 124 is transmitting and/or receiving data traffic above a threshold and consequently determine to reduce the maximum data rate for user devices communicatively coupled with the one or more RANs that are above the threshold. For example, if the RAN 118 is determined to be above the threshold, the backhaul controller 128 may instruct the RAN 118 to reduce the maximum data rate for the user device 102 and other user devices communicatively coupled with RAN 118.

In some examples, reducing the maximum data rate may additionally or alternatively be based on whether a user device may be subject to or associated with data prioritization. In some examples, determining whether the user device is subject to or associated with data prioritization may be based on receiving a device identifier that indicates to the backhaul controller 128 that the device is subject to or associated with data prioritization. As a result, the backhaul controller 128 may determine to exempt the user device from the reduction in maximum data rate or determine to reduce the user device’s maximum data rate to a higher magnitude than other user devices. For example, the backhaul controller 128 may instruct RAN 118 to exempt data traffic to and from the user device 102 based on the user device 102’s identifier. Similarly, in some examples, the backhaul controller 128 may determine, based on the identifier in the header of the packet associated with the data traffic, that a user device is transmitting or receiving low latency data or priority data (e.g., such as during operation 408) and as a result, the backhaul controller 128 may similarly determine to exempt the user device from the data rate reduction or to reduce the user device’s data rate to a higher magnitude than other user devices until the user device ceases transmitting or receiving the low latency data or the priority data.

At operation 408, the process includes determining a priority associated with the data. In some examples, as previously mentioned, the priority associated with the data may be determined by the backhaul controller 128 based on an identifier from the header of the packet associated with the data. In some examples, the backhaul controller 128 may determine two or more levels of data priority. For example, the backhaul controller 128 may determine a first priority for data associated with streaming video, online game, and/or video call and a second priority for all other data where the first priority is higher than the second priority. In some examples, priority may be determined for data associated with a service provider. For example, a higher priority may be determined for data associated with a first streaming video service and a lower priority may be determined for data associated with a second different streaming video service. In some examples, as previously mentioned, the operation 408 may also be performed in association or prior to the operation 406.

At operation 410, the process includes increasing backoff timer associated with the data traffic. In some examples, the operation 410 may include determining the increase in the backoff timer based on the data prioritization determined by the operation 408. In some examples, data associated with higher priority may be associated with a lower increase or no increase in backoff timer duration while data associated with lower priority may be associated with a higher increase in backoff timer duration. For example, data associated with streaming video, online game, and/or video call may be associated with the lower increase or no increase in the backoff timer while other data may be associated with the higher increase in the backoff timer. In some examples, the backoff timer may be increased at RAN 118, and the backhaul controller 128 may instruct the RAN to increase the backoff timer. In some examples, the RAN 118 may include a default backoff timer, where the default backoff timer is used when the data bandwidth usage is below the data bandwidth threshold (e.g., when the backoff timer is not increased).

At operation 412, the process includes determining whether a second backhaul has available bandwidth. In some examples, the second backhaul may be a backhaul that is positioned proximate to the backhaul 124. In some examples, the second backhaul may be a backhaul that is communicatively coupled with a second RAN. In some examples, the second RAN may be configured to execute a handover with the RAN 118. In some examples, the backhaul controller 128 may be communicatively coupled with a second backhaul controller that is associated with the second backhaul to determine whether the second backhaul has available bandwidth. In some examples, the second backhaul controller can determine, based on a bandwidth threshold such as second backhaul data bandwidth threshold, that the second backhaul has available bandwidth.

In some examples, when second backhaul data bandwidth usage is below the second backhaul data bandwidth threshold, the second backhaul controller can transmit an indication that the second backhaul is has available bandwidth. The backhaul controller 128 may receive the indication and determine to proceed to operation 414.

At the operation 414, the backhaul controller 128 can initiate a decrease of initial RACH power at the RAN 118. In some examples, when initiate a decrease of the initial RACH power, the backhaul controller 128 may also concurrently communicate with the second backhaul controller such that the second backhaul controller instructs the second RAN to increase its initial RACH power. In some examples, decreasing the initial RACH power of the RAN 118 may decrease a coverage area of the RAN 118. Decreasing the coverage area may cause user devices that were previously located at the edge of the coverage area of the RAN 118 to lose communicative coupling with the RAN 118. In some examples, increasing the initial RACH power at the second RAN concurrently may increase a coverage area associated with the second RAN and communicatively couple the second RAN to the user devices that lost communicative coupling with the RAN 118.

In some examples, similar to those described in association with the voice traffic in FIG. 3, the backhaul controller 128 may determine or receive a second data traffic bandwidth threshold lower than the data traffic threshold. In some examples, the backhaul controller 128 can determine to execute the operations 406, 410, and/or 414 while the data traffic bandwidth usage is at or above the data traffic bandwidth and continue the execution of the operations 406, 410, and/or 414 while the data traffic bandwidth usage is between the data traffic bandwidth threshold and the second data traffic bandwidth threshold. In some example, the backhaul controller 128 can determine to halt the operations 406, 410, and/or 414 when the data traffic bandwidth usage is below the second data traffic bandwidth usage until the data traffic bandwidth threshold is met or exceeded again.

FIG. 5 is a flow diagram illustrating an example process 500 of generating a data model for predicting network traffic congestion. In some examples, the process 500 may be executed at the backhaul controller 128. Alternatively, the process 500 may be executed at a remote computing device. In some examples, the process 500 may be associated with monitoring network traffic at the backhaul 124.

At operation 502, the process includes determining a first time when bandwidth usage meets or exceeds a bandwidth usage threshold. In some examples, the operation 502 may include determining a type of bandwidth usage threshold being met or exceeded such as upstream network traffic, downstream network traffic, voice traffic, and/or data traffic.

At operation 504, the process includes associating the first time with an occurrence of an event. Examples of the event may include but not limited to morning rush, evening rush, a sporting event, a concert, a convention, a holiday, a march, a festival and/or the like. In some examples, the backhaul controller 128 may determine the event based on historical data, calendar data, a time of day, and/or the like. In some examples, the operation 504 can include identifying the type of event (e.g., a sporting event, a concert, a festival, etc.). In some example, the first time may be associated with a start of the event. In some examples, the backhaul controller 128 may further associate the event with a particular type of bandwidth congestion. For example, during a concert, upstream traffic usage may exceed the upstream bandwidth threshold and data traffic may exceed the data bandwidth threshold and the backhaul controller 128 may associated the concert with upstream traffic and data traffic congestion and the backhaul controller 128 may proactively determine and execute activities designed to mitigate upstream traffic and data traffic congestion when the backhaul controller 128 determines a concert event in the future.

At operation 506, the process can include determining a second time when the bandwidth usage is below the bandwidth threshold. When the second time is determined, then at operation 508, the process can include associating the second time with an end of the event. In some examples, the second time period may not necessarily indicate an end of the actual event, but indicate that the event no longer requires the bandwidth usage that causes congestion.

At operation 510, the process can include determining a period of time associated with the first time and the second time. In some examples, the period of time may indicate an elapsed period of time between the first time and the second time.

At operation 512, the process can include associating the period of time with a duration of the event. In some examples, the period of time may be associated with a duration of the event that between when bandwidth congestion starts and when the bandwidth congestion ends.

At operation 514, the process can include generating a data model that includes the period of time and the event. In some examples, the data model can also include the type of event and the type of bandwidth congestion the event is associated with (e.g., video bandwidth congestion, voice bandwidth congestion, etc.). While FIG. 5 illustrates generating the data model based on one event, it is contemplated that the data model may include a plurality of events, each event being associated with one or more types of bandwidth congestion and respective period of time. In some examples, each event may include an event identifier indicating the type of event. In some examples, the backhaul controller 128 can update the events based on continuous monitoring of network traffic at the backhaul 124.

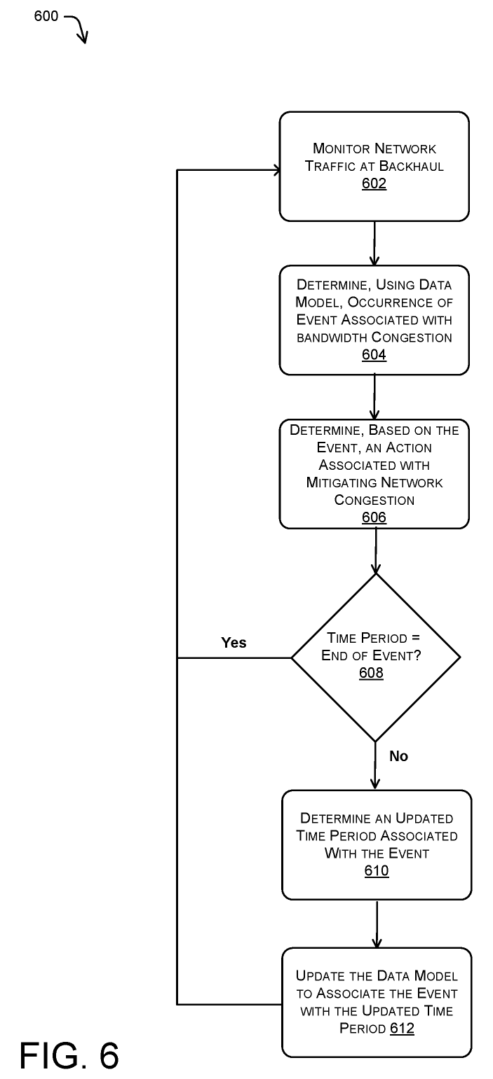

FIG. 6 is a flow diagram of an example process 600 of using a data model to proactively mitigate bandwidth congestion. In some examples, the process 600 may be performed by the backhaul controller 128. In some examples, the data model may correspond to the data model described in association with FIG. 5.

At operation 602, the process can include monitoring network traffic at the backhaul 124. In some examples, the backhaul controller 128 can monitor bandwidth usage for upstream traffic, downstream traffic, voice traffic, and/or data traffic. In some examples, the operation 602 can include the backhaul controller 128 monitoring for patterns within bandwidth usage such as a gradual increase in bandwidth usage over a threshold period of time or a sudden increase in bandwidth usage over threshold magnitude or percentage. For example, the backhaul controller 128 may be monitoring the data traffic bandwidth usage for sudden 20% or more increase in bandwidth usage.

At operation 604, the process can include determining, based on the data model, an event associated with bandwidth congestion. In some examples, while the backhaul controller 128 is continuously monitoring network traffic, the backhaul controller 128 may continuously access the data model to determine whether the event has occurred. In some examples, the backhaul controller 128 may determine based on historical data, calendar data, a time of day, and/or the like and the data model that the event has occurred. In some examples, the backhaul controller 128 may access the data model to determine whether the event has occurred when the backhaul controller 128 determines the gradual increase in bandwidth usage over a threshold period of time or a sudden increase in bandwidth usage over threshold magnitude or percentage.

At operation 606, the process can include determining an action associated with mitigating bandwidth congestion that is associated with the event. In some examples, the backhaul controller 128 may determine the action based on the data model. For example, the backhaul controller 128 may determine, using the data model, that the event is a concert and further determine, based on the event being a concert and using the data model, to determine and execute action(s) associated with reducing bandwidth usage of data traffic and/or upstream traffic. In some examples, the backhaul controller 128 may determine to continue executing the action(s) until the event ends.

At operation 608, the process can include determining whether a time period that is predicted by the data model and associated with the occurrence of the event actually indicates an end of the event. In some examples, the time period may correspond to the period of time determined during the operations 510 and 512. In some examples, the end of the event may be determined as when the bandwidth usage is below the bandwidth threshold. For example, when the event is a concert, the end of the event may be when the data traffic bandwidth usage is below the data traffic bandwidth threshold. When the backhaul controller 128 determines that the time period does indicate an end of the event, then the backhaul controller 128 may stop the action(s) and return to performing the operation 602. When the backhaul controller 128 determines that the time period does not indicate an end of the event, then the process may proceed to operation 610 where an updated time period may be determined for the event. At operation 610, the process may include determining an updated time associated with the end of the event and, based on the updated time, an updated time period associated with the event.

At operation 612, process can include updating the data model to associate the event with the updated time period. In some examples, the operation 612 can include the backhaul controller 128 replacing the time period associated with the event with the updated time period. In some examples, the updated time period may be used when the data model is used by backhaul controller 128 in the future.

FIGS. 2-6 illustrate example processes and sequence diagrams in accordance with examples of the disclosure. These processes are illustrated as logical flow graphs, each operation of which represents a sequence of operations that can be implemented in hardware, software, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be combined in any order, omitted, and/or performed in parallel to implement the processes.

### Conclusion

Although the subject matter has been described in language specific to structural features and/or methodological acts, it is to be understood that the subject matter is not necessarily limited to the specific features or acts described above. Rather, the specific features and acts described above are disclosed as example embodiments.

While one or more examples of the techniques described herein have been described, various alterations, additions, permutations and equivalents thereof are included within the scope of the techniques described herein. For instance, systems and techniques described in FIGS. 1-6 can be combined in various ways.

In the description of examples, reference is made to the accompanying drawings that form a part hereof, which show by way of illustration specific examples of the claimed subject matter. It is to be understood that other examples can be used and that changes or alterations, such as structural changes, can be made. Such examples, changes or alterations are not necessarily departures from the scope with respect to the intended claimed subject matter. While the steps herein can be presented in a certain order, in some cases the ordering can be changed so that certain inputs are provided at different times or in a different order without changing the function of the systems and methods described. The disclosed procedures could also be executed in different orders. Additionally, various computations that are herein need not be performed in the order disclosed, and other examples using alternative orderings of the computations could be readily implemented. In addition to being reordered, the computations could also be decomposed into sub-computations with the same results.

What is claimed is:

1. A system comprising:
one or more processors; and
one or more non-transitory computer-readable media storing computer-executable instructions that, when executed by the one or more processors, cause the system to perform operations comprising:
determining, based on network traffic, a bandwidth usage at a backhaul of a telecommunication network;
determining that the bandwidth usage is at or above a bandwidth threshold;
determining, in response to the bandwidth usage being at or above the bandwidth threshold, whether the bandwidth usage is associated with one of voice traffic or data traffic;
determining, based on the bandwidth usage being associated with voice traffic, a first action configured to lower voice traffic bandwidth usage;
determining, based on the bandwidth usage being associated with data traffic, a second action configured to lower data traffic bandwidth usage; and
executing, by the system, the first action or the second action.

2. The system of claim 1, wherein the bandwidth usage is associated with the voice traffic and the first action comprises:
in response to a bandwidth usage at a base station communicatively coupled with the backhaul being less than a base station bandwidth threshold, generating by the base station, second voice traffic that corresponds to the voice traffic; and
transmitting the voice traffic and the second voice traffic to a device communicatively coupled with the telecommunication network.

3. The system of claim 1, wherein the bandwidth usage is associated with the data traffic and the second action comprises:
determining a priority for additional data traffic associated with a user device that is in communication with a base station communicatively coupled with the backhaul; and determining, based on the priority, at least one of:
a magnitude of maximum data rate reduction for the user device; or
a magnitude of an increase in a backoff timer of the additional data traffic associated with the user device.

4. The system of claim 1, wherein executing the first action comprises sending an instruction to a base station communicatively coupled with the backhaul to perform the first action.

5. The system of claim 1, wherein the system is physically coupled to the backhaul.

6. A method comprising:
determining bandwidth usage at a backhaul of a telecommunication network;
determining, in response to the bandwidth usage being above a bandwidth threshold, a type of network traffic associated with the bandwidth usage;
determining, based on the type of network traffic, an action configured to lower the bandwidth usage; and
executing the action to lower the bandwidth usage.

7. The method of claim 6, wherein the type of network traffic comprises voice traffic.

8. The method of claim 7, wherein determining the action comprises:
in response to a bandwidth usage at a base station communicatively coupled with the backhaul being less than a base station bandwidth threshold, generating, by the base station, second voice traffic that corresponds to the voice traffic; and
transmitting the voice traffic and the second voice traffic to a device communicatively coupled with the telecommunication network.

9. The method of claim 7, wherein determining the action comprises:
determining that new voice traffic received at a first base station communicatively coupled with the backhaul is transmitted from a second base station communicatively coupled with the first base station; and
permitting, based on the new voice traffic being received from the second base station, transmission of the new voice traffic from the first base station to the backhaul.

10. The method of claim 7, wherein the action comprises:
determining that new voice traffic received at a base station communicatively coupled with the backhaul is transmitted from a user device that is in communication with the base station; and
restricting, based on the new voice traffic being received from the user device, transmission of the new voice traffic from the base station to the backhaul.

11. The method of claim 7, the action comprises increasing a backoff timer associated with new voice traffic received at a base station communicatively coupled with the backhaul.

12. The method of claim 6, wherein the type of network traffic comprises data traffic.

13. The method of claim 12, further comprising determining a priority for data traffic associated with a user device that is in communication with a base station communicatively coupled with the backhaul.

14. The method of claim 13, wherein the action comprises at least one of:
determining, based on the priority, a magnitude of maximum data rate reduction for the user device; or
determining, based on the priority, a magnitude of an increase in a backoff timer for the data traffic associated with the user device.

15. The method of claim 12, wherein the action comprises:
reducing, in response to determining that a bandwidth usage at a second backhaul communicatively coupled with the backhaul is below a second bandwidth threshold, an initial random access channel power of a first base station communicatively coupled with the backhaul; and
increasing, in response to the determining that the bandwidth usage at the second backhaul is below the second bandwidth threshold, an initial random access channel power of a second base station communicatively coupled with the second backhaul.

16. One or more non-transitory computer-readable media storing instructions executable by one or more processors, wherein the instructions, when executed, cause the one or more processors to perform operations comprising:
determining bandwidth usage at a backhaul of a telecommunication network;
determining, in response to the bandwidth usage being above a bandwidth threshold, a type of network traffic associated with the bandwidth usage;
determining, based on the type of network traffic, an action configured to lower the bandwidth usage; and
executing the action to lower the bandwidth usage.

17. The one or more non-transitory computer-readable media of claim 16 wherein the type of network traffic comprises voice traffic, determining the action comprises:
in response to a bandwidth usage at a base station communicatively coupled with the backhaul being less than a base station bandwidth threshold, generating by the base station, second voice traffic that corresponds to the voice traffic; and
transmitting the voice traffic and the second voice traffic to a device communicatively coupled with the telecommunication network.

18. The one or more non-transitory computer-readable media of claim 16, the type of network traffic comprises voice traffic, determining the action comprises:
determining that new voice traffic received at a first base station communicatively coupled with the backhaul is transmitted from a second base station communicatively coupled with the first base station; and
permitting, based on the new voice traffic being received from the second base station, transmission of the new voice traffic from the first base station to the backhaul.

19. The one or more non-transitory computer-readable media of claim 16, wherein the type of network traffic comprises data traffic, the operations further comprising determining a priority for data traffic associated with a user device that is in communication with a base station communicatively coupled with the backhaul.

20. The one or more non-transitory computer-readable media of claim 19, wherein the action comprises at least one of:
determining, based on the priority, a magnitude of maximum data rate reduction for the user device; or
determining, based on the priority, a magnitude of an increase in a backoff timer for the data traffic associated with the user device.
